(19) United States
(12) Patent Application Publication
(10) Pub. No.: US 2006/0285456 A1
(43) Pub. Date: Dec. 21, 2006

(54) Optical disc signal processing apparatus and optical disc reproduction apparatus

(76) Inventors: Tadayoshi Ishikawa, Kyoto (JP); Kouji Kitamura, Kyoto (JP); Noriaki Sasaki, Osaka (JP); Katsutoshi Ohta, Kyoto (JP)

Correspondence Address: MCDERMOTT WILL & EMERY LLP, 600 13TH STREET, N.W., WASHINGTON, DC, 20005-3096, US

(21) Appl. No.: 11/452,953

(22) Filed: Jun. 15, 2006

(30) Foreign Application Priority Data
Jun. 16, 2005 (JP) 2005-175985

(51) Int. Cl. G11B 19/00

(52) U.S. Cl. 369/47.46; 369/47.41

(57) ABSTRACT

An optical disc signal processing apparatus is provided which comprises a rotation control section for measuring and outputting the number of edges within a predetermined time for a binary signal obtained from an RF signal reproduced from an optical disc on which information is recorded, a detecting section for detecting a missing portion of the RF signal, and a parameter control section for, when a missing portion of the RF signal is not detected, calculating and outputting a rotation control parameter for controlling a rotation of the optical disc based on the number of edges obtained by the rotation control section, and when a missing portion of the RF signal is detected, controlling the rotation control parameter so that an influence of the missing portion of the RF signal is suppressed.

### BACKGROUND OF THE INVENTION

The present invention relates to an optical disc reproduction apparatus, and more particularly, to a control of rotation of a spindle motor which rotates an optical disc.

In recent years, it has become increasingly important to manage the copyright of content information. Regarding DVD (digital versatile disc), copyright management is performed using an area called a BCA (Burst Cutting Area) or an NBCA (Narrow Burst Cutting Area), which are provided in the vicinity of a lead-in area of an inner periphery or a specific area provided further inside. In the BCA area, additional information is recorded by intermittently removing recorded information using laser after the production process of a disc is ended in a factory or the like.

In the BCA area, information is partially missing, so that a rotation control cannot be expected to be performed using a pit on an optical disc, and a control method which does not depend on a pit is often used. For example, when the rotation of a spindle motor is directly detected, a rotation control can be performed using a signal which contains a predetermined number of pulses per revolution of a disc (hereinafter referred to as an FG (Frequency Generator) signal). However, in recently years, a system which does not use the FG signal, in order to achieve an inexpensive system, has been increasingly widely used, and a system which performs a rotation control in the BCA area only by applying a predetermined drive voltage to the spindle motor has also been increasingly widely used.

Hereinafter, the conventional rotation control in the BCA area which does not use the FG signal will be described. FIG. 11 is a block diagram illustrating an exemplary configuration of a conventional optical disc reproduction apparatus. The disc reproduction apparatus of FIG. 11 comprises a spindle motor 12, an optical pickup 94, an RF (Radio Frequency) signal obtaining section 96, a rotation control section 97, and a drive section 98.

The optical pickup 94 has an objective lens which emits and condenses laser light. The optical pickup 94 irradiates a disc 2 with laser and detects reflected light from the disc 2 to generate an RF signal. The RF signal obtaining section 96 receives the RF signal from the optical pickup 94 and counts rising/falling edges of the RF signal within a predetermined time. The rotation control section 97 monitors a change in the count and controls the drive section 98 so as to keep a rotational speed constant. The drive section 98 drives the spindle motor 12 in accordance with the rotation control section 97 to rotate the disc 2.

A related technique is disclosed in JP No. 2002-279624 A.

However, in the BCA area, information recorded in an optical disc is missing, so that an RF signal may be missing as illustrated in FIG. 2. In this case, the number of counts obtained by the RF signal obtaining section 96 decreases, so that the rotational speed is controlled to be temporarily increased. An increase in the rotational speed in turn leads to an increase in the number of counts obtained by the RF signal obtaining section 96. In this case, conversely, the rotational speed is controlled to be decreased. Thus, although the rotational speed is controlled to be kept constant, the rotation becomes irregular due to the missing RF signal. In other words, a stable rotation control cannot be achieved, likely leading to a situation that the rotation cannot be controlled.

### SUMMARY OF THE INVENTION

An object of the present invention is to achieve a stable rotation control with respect to an optical disc, based on a signal read from the optical disc.

Specifically, the present invention provides an optical disc signal processing apparatus comprising a rotation control section for measuring and outputting the number of edges within a predetermined time for a binary signal obtained from an RF (Radio Frequency) signal reproduced from an optical disc on which information is recorded, a detecting section for detecting a missing portion of the RF signal, and a parameter control section for, when a missing portion of the RF signal is not detected, calculating and outputting a rotation control parameter for controlling a rotation of the optical disc based on the number of edges obtained by the rotation control section, and when a missing portion of the RF signal is detected, controlling the rotation control parameter so that an influence of the missing portion of the RF signal is suppressed.

Thereby, when a missing portion occurs in an RF signal, it is possible to avoid an erroneous rotation control based on the RF signal, so that a variation in the rotational speed of an optical disc can be suppressed.

Preferably, in the optical disc signal processing apparatus, when a missing portion of the RF signal is detected, the parameter control section does not output the rotation control parameter.

Preferably, in the optical disc signal processing apparatus, when a missing portion of the RF signal is detected, the parameter control section adds a predetermined offset to the number of edges obtained by the rotation control section, and based on the resultant value, calculates and outputs the rotation control parameter.

Preferably, in the optical disc signal processing apparatus, the parameter control section stores the rotation control parameter, and when a missing portion of the RF signal is detected, outputs the rotation control parameter which was previously output.

Preferably, in the optical disc signal processing apparatus, the detecting section detects a length of a time period during which the RF signal is missing, and when a missing portion of the RF signal is detected, the parameter control section adds a predetermined offset corresponding to the length of the time period during which the RF signal is missing to the number of edges obtained by the rotation control section, and based on the resultant value, calculates and outputs the rotation control parameter.

Preferably, in the optical disc signal processing apparatus, the detecting section calculates a length of an information area in which the RF signal is not missing and a length of an additional information area in which the RF signal is missing, and when a missing portion of the RF signal is detected, the parameter control section adds an offset corresponding to a ratio of the length of the information area to the length of the additional information area to the number of edges obtained by the rotation control section, and based on the resultant value, calculates and outputs the rotation control parameter.

Preferably, in the optical disc signal processing apparatus, the detecting section measures the number of edges which are missing in the RF signal, and outputs the resultant value, and the parameter control section adds an offset corresponding to the number of missing edges to the number of edges obtained by the rotation control section, and based on the resultant value, calculates and outputs the rotation control parameter.

The present invention also provides an optical disc reproduction apparatus comprising an optical pickup for irradiating an optical disc recording information with a light beam, detecting reflected light from the optical disc, and outputting the detected signal as an RF signal, an RF signal obtaining section for controlling the optical pickup to perform a tracking control of the light beam, converting the RF signal into a binary signal, and outputting the binary signal, a rotation control section for measuring and outputting the number of edges within a predetermined time for the binary signal obtained from the RF signal, a detecting section for detecting a missing portion of the RF signal, and a parameter control section for, when a missing portion of the RF signal is not detected, calculating and outputting a rotation control parameter for controlling a rotation of the optical disc based on the number of edges obtained by the rotation control section, and when a missing portion of the RF signal is detected, controlling the rotation control parameter so that an influence of the missing portion of the RF signal is suppressed.

According to the present invention, in an inexpensive optical disc reproduction apparatus which performs a rotation control based on a signal read from an optical disc, it is possible to perform a stable rotation control of the optical disc even if an RF signal is missing in the BCA area.

### BRIEF DESCRIPTION OF THE DRAWINGS

FIG. 1 is a block diagram illustrating an optical disc reproduction apparatus according to a first embodiment of the present invention.

FIG. 2 is an explanatory diagram illustrating an RF signal output from an optical pickup of FIG. 1.

FIG. 3 is a flowchart illustrating a process flow of the optical disc signal processing apparatus of FIG. 1.

FIG. 4 is a block diagram illustrating an optical disc reproduction apparatus according to a second embodiment of the present invention.

FIG. 5 is a flowchart illustrating a process flow of the optical disc signal processing apparatus of FIG. 4.

FIG. 6 is a block diagram illustrating an optical disc reproduction apparatus according to a third embodiment of the present invention.

FIG. 7 is a flowchart illustrating a process flow of the optical disc signal processing apparatus of FIG. 6.

FIG. 8 is a block diagram illustrating an optical disc reproduction apparatus according to a fourth embodiment of the present invention.

FIG. 9 is a graph illustrating an exemplary offset value which is used by a parameter offset control section of FIG. 8.

FIG. 10 is a block diagram illustrating an optical disc reproduction apparatus according to a fifth embodiment of the present invention.

FIG. 11 is a block diagram illustrating an exemplary configuration of a conventional optical disc reproduction apparatus.

### DETAILED DESCRIPTION OF THE PREFFERED EMBODYMENTS

Hereinafter, embodiments of the present invention will be described with reference to the accompanying drawings. Like reference characters designate like parts throughout the various figures of the drawings.

### First Embodiment

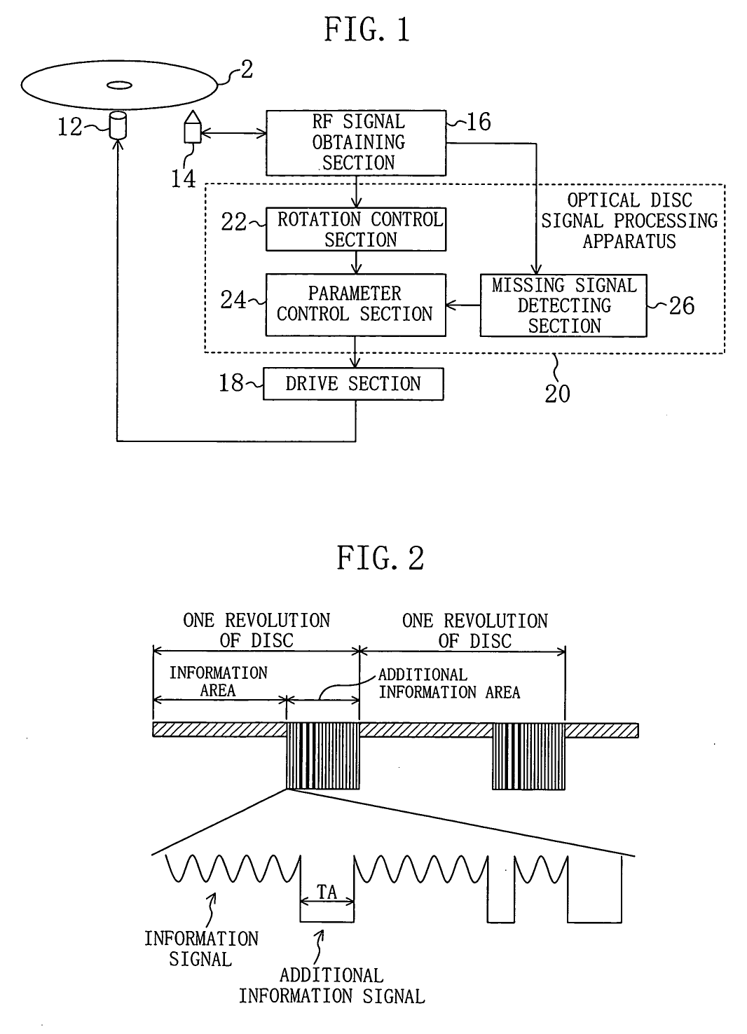

FIG. 1 is a block diagram illustrating an optical disc reproduction apparatus according to a first embodiment of the present invention. The optical disc reproduction apparatus of FIG. 1 comprises a spindle motor 12, an optical pickup 14, an RF signal obtaining section 16, a drive section 18, and an optical disc signal processing apparatus 20. The optical disc signal processing apparatus 20 comprises a rotation control section 22, a parameter control section 24, and a missing signal detecting section 26 (detecting section).

FIG. 2 is an explanatory diagram illustrating an RF signal output from the optical pickup 14 of FIG. 1. As can be seen from an enlarged view provided in a lower portion of FIG. 2, an RF signal obtained about the BCA area on the optical the disc 2 repeatedly includes an information signal indicating information recorded on the optical disc 2, and an additional information signal indicating a missing portion of the information recorded on the optical disc 2 (i.e., a time period TA during which the RF signal is missing, etc.).

The spindle motor 12 rotates the optical disc 2. The optical pickup 14 has an objective lens which emits and condenses laser light. The optical pickup 14 irradiates the optical disc 2 with laser light and detects reflected light from the optical disc 2 to output the detected signal as an RF signal. The RF signal obtaining section 16 controls the optical pickup 14 to perform a tracking control with respect to a light beam, and in addition, receives the RF signal from the optical pickup 14, converts the signal into a binary signal using a predetermined threshold value, and outputs the binary signal to the rotation control section 22. The RF signal obtaining section 16 also outputs the RF signal to the missing signal detecting section 26.

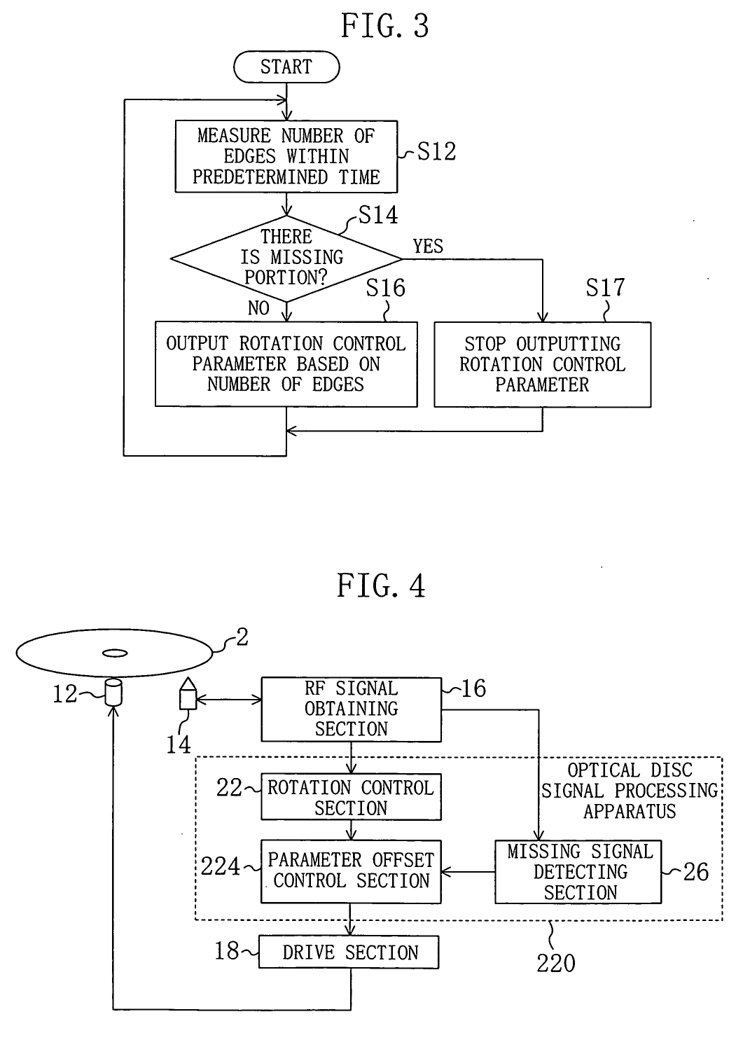

FIG. 3 is a flowchart illustrating a process flow of the optical disc signal processing apparatus 20 of FIG. 1. In step S12 of FIG. 3, the rotation control section 22 counts rising/falling edges of the binary RF signal to measure the number of edges within a predetermine time, and outputs the result to the parameter control section 24.

In step S14, the missing signal detecting section 26 determines whether or not the RF signal has a missing portion, and outputs the result to the parameter control section 24. When the RF signal does not have a missing portion, the process goes to step S 16. When the RF signal has a missing portion, the process goes to step S17.

In step S16, the parameter control section 24 outputs a rotation control parameter to the drive section 18 so that the rotational speed of the optical disc 2 becomes constant, based on the measured number of edges within the predetermined time. Specifically, when the measured number of edges within the predetermined time is smaller than a predetermined value, the parameter control section 24 determines that the rotation is slow, and outputs a rotation control parameter which increases the rotational speed of the spindle motor 12. When the measured number of edges within the predetermined time is larger than the predetermined value, the parameter control section 24 determines that the rotation is fast, and outputs a rotation control parameter which decreases the rotational speed of the spindle motor 12.

When the RF signal has a missing portion, the measured number of edges within the predetermined time is smaller than when the RF signal does not have a missing portion. It is not possible to perform a correct rotation control based on the number of edges having such an error. Therefore, in step S17, the parameter control section 24 does not output a rotation control parameter, so that an influence of a missing portion of the RF signal is suppressed. In other words, the parameter control section 24 does not perform a rotation control, so that the spindle motor 12 is caused to keep a current rotation state (free run state).

Thereafter, the drive section 18 drives the spindle motor 12 in accordance with a rotation control parameter, and the process returns to step S12.

As described above, according to the optical disc signal processing apparatus 20 of FIG. 1, when the RF signal has a missing portion, a rotation control is not performed. Therefore, a rotation control which erroneously increases the rotational speed of the optical disc 2 can be avoided, thereby making it possible to suppress a variation in the rotational speed of the optical disc 2. Therefore, a stable rotation control can be performed with respect to the optical disc 2 without directly detecting the rotation of the spindle motor 12.

### Second Embodiment

FIG. 4 is a block diagram illustrating an optical disc reproduction apparatus according to a second embodiment of the present invention. The optical disc reproduction apparatus of FIG. 4 is the same as the optical disc reproduction apparatus of FIG. 1, except that an optical disc signal processing apparatus 220 is provided in place of the optical disc signal processing apparatus 20. The optical disc signal processing apparatus 220 is the same as the optical disc signal processing apparatus 20 of FIG. 1, except that a parameter offset control section 224 as a parameter control section is provided in place of the parameter control section 24.

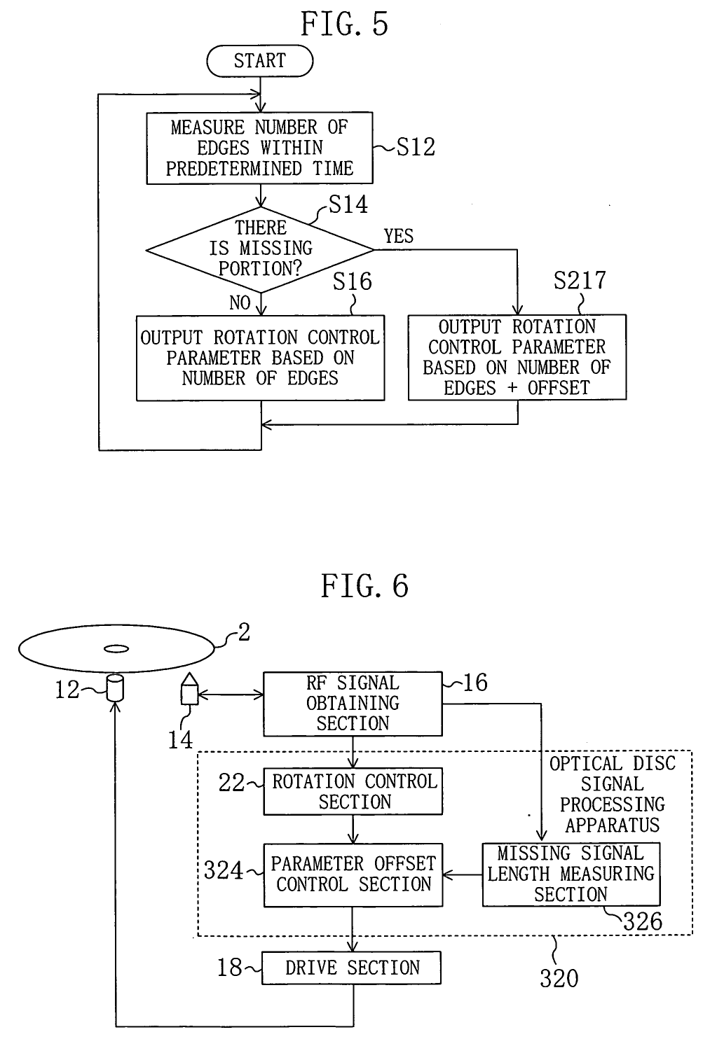

FIG. 5 is a flowchart illustrating a process flow of the optical disc signal processing apparatus 220 of FIG. 4. The flowchart of FIG. 5 is the same as the flowchart of FIG. 3, except that step S17 is replaced with step S217. The other steps are the same as those of FIG. 3.

When the RF signal has a missing portion, the measured number of edges within the predetermined time is smaller than when the RF signal does not have a missing portion. If a rotation control is performed based on the number of edges having such an error, the rotational speed is accelerated. Therefore, in step S217 of FIG. 5, the parameter offset control section 224 adds a predetermined offset to the number of edges within the predetermined time measured by the rotation control section 22 so as to suppress an influence of a missing portion of the RF signal, and based on the resultant value, calculates and outputs a rotation control parameter in a manner similar to that of step S16 of FIG. 3.

Note that the parameter offset control section 224 may store the rotation control parameter, and when the RF signal has a missing portion, may output the stored rotation control parameter which was previously output.

As described above, according to the optical disc signal processing apparatus 220 of FIG. 4, when the RF signal has a missing portion, an offset is added to the measured number of edges, thereby making it possible to suppress the influence of the missing portion of the RF signal. Therefore, an erroneous rotation control can be avoided, thereby making it possible to suppress a variation in the rotational speed of the optical disc 2.

### Third Embodiment

FIG. 6 is a block diagram illustrating an optical disc reproduction apparatus according to a third embodiment of the present invention. The optical disc reproduction apparatus of FIG. 6 is the same as the optical disc reproduction apparatus of FIG. 1, except that an optical disc signal processing apparatus 320 is provided in place of the optical disc signal processing apparatus 20. The optical disc signal processing apparatus 320 is the same as the optical disc signal processing apparatus 20 of FIG. 1, except that a parameter offset control section 324 as a parameter control section and a missing signal length measuring section 326 as a detecting section are provided in place of the parameter control section 24 and the missing signal detecting section 26.

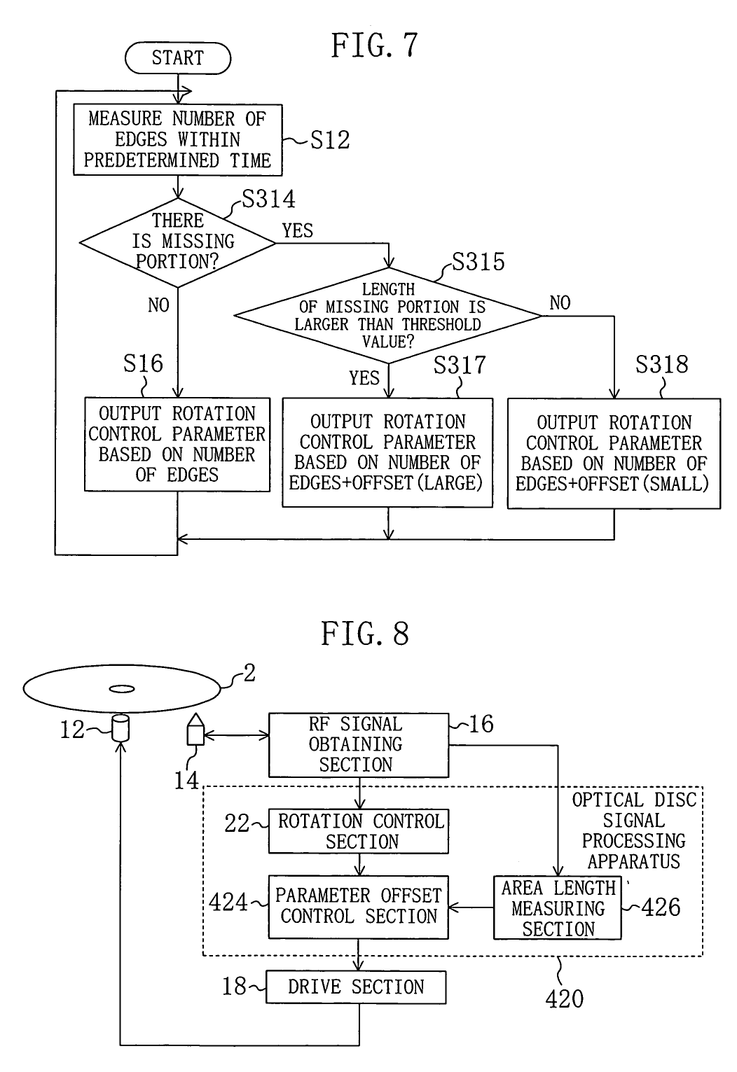

FIG. 7 is a flowchart illustrating a process flow of the optical disc signal processing apparatus 320 of FIG. 6. The flowchart of FIG. 7 is the same as the flowchart of FIG. 3, except that step S14 is replaced with step S314, and step S17 is replaced with steps S315, S317, and S318. The other steps are the same as those of FIG. 3.

In step S314 of FIG. 7, the missing signal length measuring section 326 measures a length of a missing portion of the RF signal, and outputs the result to the parameter offset control section 324. When the RF signal does not have a missing portion, the process goes to step S16. When the RF signal has a missing portion, the process goes to step S315.

In step S315, the parameter offset control section 324 compares the length of the missing portion of the RF signal with a predetermined threshold value. When the missing portion length is larger than the predetermined threshold value, the process goes to step S317, and when otherwise, the process goes to step S318.

In step S317, the parameter offset control section 324 adds a predetermined offset (large offset) to the number of edges within the predetermined time measured by the rotation control section 22 so as to suppress the influence of the missing portion of the RF signal, and based on the resultant value, calculates and outputs a rotation control parameter in a manner similar to that of step S16 of FIG. 3.

In step S318, the parameter offset control section 324 adds a predetermined offset (small offset) which is smaller than that of step S317 to the number of edges within the predetermined time measured by the rotation control section 22 so as to suppress the influence of the missing portion of the RF signal, and based on the resultant value, calculates and outputs a rotation control parameter in a manner similar to that of step S16 of FIG. 3.

As described above, according to the optical disc signal processing apparatus 320 of FIG. 6, a value added to the measured number of edges is changed, depending on the length of a missing portion of the RF signal. Thereby, the influence of a missing portion of the RF signal can be more appropriately suppressed, thereby making it possible to suppress a variation in the rotational speed of the optical disc 2.

### Fourth Embodiment

FIG. 8 is a block diagram illustrating an optical disc reproduction apparatus according to a fourth embodiment of the present invention. The optical disc reproduction apparatus of FIG. 8 is the same as the optical disc reproduction apparatus of FIG. 1, except that an optical disc signal processing apparatus 420 is provided in place of the optical disc signal processing apparatus 20. The optical disc signal processing apparatus 420 is the same as the optical disc signal processing apparatus 20 of FIG. 1, except that a parameter offset control section 424 as a parameter control section and an area length measuring section 426 as a detecting section are provided in place of the parameter control section 24 and the missing signal detecting section 26.

As illustrated in FIG. 2, an RF signal obtained about the BCA area of the optical disc 2 includes an information area in which the RF signal does not have a missing portion and an additional information area in which the RF signal may have a missing portion. The area length measuring section 426 calculates lengths of the information area and the additional information area illustrated in FIG. 2, and outputs the lengths to the parameter offset control section 424.

The parameter offset control section 424 adds an offset corresponding to a ratio of the length of the information area to the length of the additional information area to the number of edges within the predetermined time measured by the rotation control section 22, and based on the resultant value, calculates and outputs a rotation control parameter in a manner similar to that of step S16 of FIG. 3.

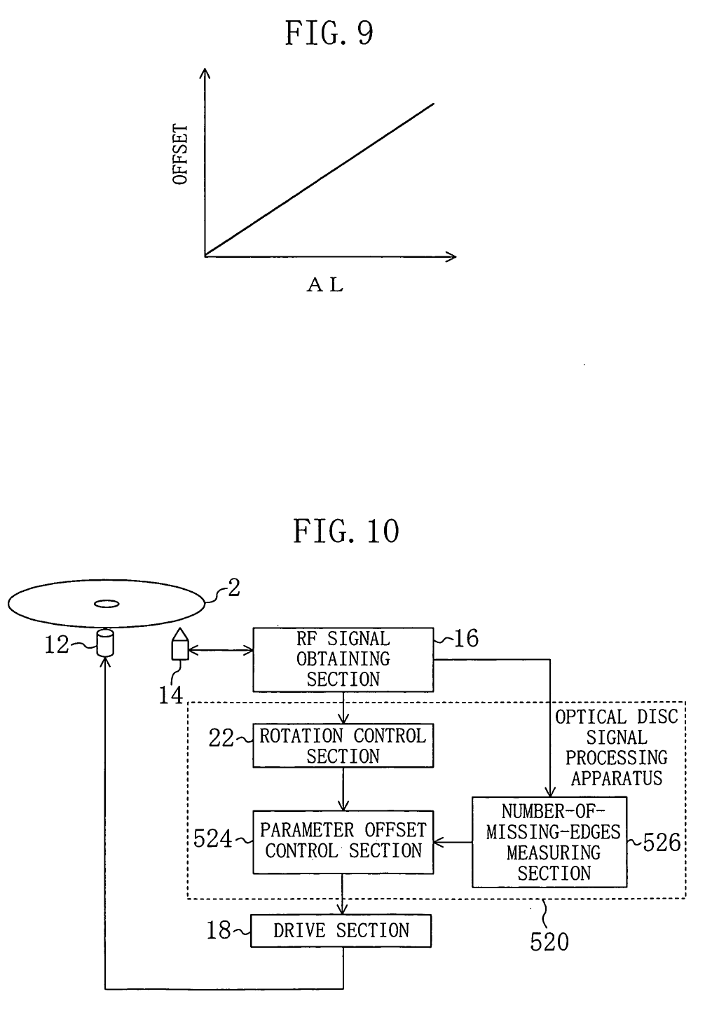

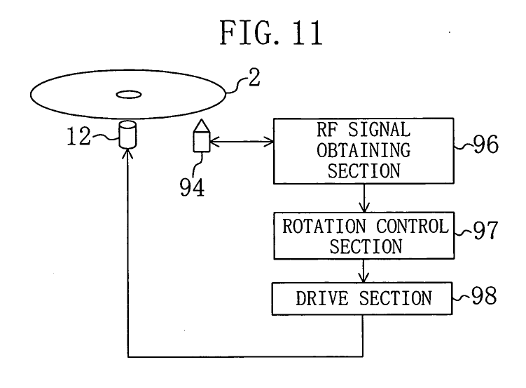

FIG. 9 is a graph illustrating an exemplary offset value which is used by the parameter offset control section 424 of FIG. 8. For example, as illustrated in FIG. 9, the parameter offset control section 424 uses, as an offset, a value in proportion to AL = (the length of the additional information area)/(the length of the information area + the length of the additional information area).

After an offset has been once obtained in this manner, the obtained offset can be repeatedly used for the disc. Therefore, after an offset has been once obtained, the parameter offset control section 424 adds the same offset to the number of edges within the predetermined time measured by the rotation control section 22 every revolution of the optical disc 2.

As described above, according to the optical disc signal processing apparatus 420 of FIG. 8, a variation in the rotational speed of the optical disc 2 can be suppressed without calculating an offset every revolution of the optical disc 2.

### Fifth Embodiment

FIG. 10 is a block diagram illustrating an optical disc reproduction apparatus according to a fifth embodiment of the present invention. The optical disc reproduction apparatus of FIG. 10 is the same as the optical disc reproduction apparatus of FIG. 1, except that an optical disc signal processing apparatus 520 is provided in place of the optical disc signal processing apparatus 20. The optical disc signal processing apparatus 520 is the same as the optical disc signal processing apparatus 20 of FIG. 1, except that a parameter offset control section 524 as a parameter control section and a number-of-missing-edges measuring section 526 as a detecting section are provided in place of the parameter control section 24 and the missing signal detecting section 26.

The number-of-missing-edges measuring section 526 measures the number of missing edges of the RF signal within a time period of one revolution of a disc, and outputs the resultant value to the parameter offset control section 524. The parameter offset control section 524 adds the number of missing edges as an offset to the number of edges within the predetermined time measured by the rotation control section 22, and based on the resultant value, calculates and outputs a rotation control parameter in a manner similar to that of step S16 of FIG. 3.

In the optical disc signal processing apparatus 520 of FIG. 10, after an offset has been once obtained, the obtained offset can be repeatedly used for the disc. Therefore, after an offset has been once obtained, the parameter offset control section 524 adds the same offset to the number of edges within a predetermined time measured by the rotation control section 22 every revolution of the optical disc 2.

As described above, according to the optical disc signal processing apparatus 520 of FIG. 10, a variation in the rotational speed of the optical disc 2 can be suppressed without calculating an offset every revolution of the optical disc 2.

As has been heretofore described, the present invention can perform a stable rotation control with respect to a spindle motor, and therefore, is useful for an optical disc reproduction apparatus and the like.

What is claimed is:

1. An optical disc signal processing apparatus comprising:
a rotation control section for measuring and outputting the number of edges within a predetermined time for a binary signal obtained from an RF (Radio Frequency) signal reproduced from an optical disc on which information is recorded;
a detecting section for detecting a missing portion of the RF signal; and
a parameter control section for, when a missing portion of the RF signal is not detected, calculating and outputting a rotation control parameter for controlling a rotation of the optical disc based on the number of edges obtained by the rotation control section, and when a missing portion of the RF signal is detected, controlling the rotation control parameter so that an influence of the missing portion of the RF signal is suppressed.

2. The optical disc signal processing apparatus of claim 1, wherein, when a missing portion of the RF signal is detected, the parameter control section does not output the rotation control parameter.

3. The optical disc signal processing apparatus of claim 1, wherein, when a missing portion of the RF signal is detected, the parameter control section adds a predetermined offset to the number of edges obtained by the rotation control section, and based on the resultant value, calculates and outputs the rotation control parameter.

4. The optical disc signal processing apparatus of claim 1, wherein the parameter control section stores the rotation control parameter, and when a missing portion of the RF signal is detected, outputs the rotation control parameter which was previously output.

5. The optical disc signal processing apparatus of claim 1, wherein the detecting section detects a length of a time period during which the RF signal is missing, and
when a missing portion of the RF signal is detected, the parameter control section adds a predetermined offset corresponding to the length of the time period during which the RF signal is missing to the number of edges obtained by the rotation control section, and based on the resultant value, calculates and outputs the rotation control parameter.

6. The optical disc signal processing apparatus of claim 1, wherein the detecting section calculates a length of an information area in which the RF signal is not missing and a length of an additional information area in which the RF signal is missing, and
when a missing portion of the RF signal is detected, the parameter control section adds an offset corresponding to a ratio of the length of the information area to the length of the additional information area to the number of edges obtained by the rotation control section, and based on the resultant value, calculates and outputs the rotation control parameter.

7. The optical disc signal processing apparatus of claim 1, wherein the detecting section measures the number of edges which are missing in the RF signal, and outputs the resultant value, and
the parameter control section adds an offset corresponding to the number of missing edges to the number of edges obtained by the rotation control section, and based on the resultant value, calculates and outputs the rotation control parameter.

8. An optical disc reproduction apparatus comprising:
an optical pickup for irradiating an optical disc recording information with a light beam, detecting reflected light from the optical disc, and outputting the detected signal as an RF signal;
an RF signal obtaining section for controlling the optical pickup to perform a tracking control of the light beam, converting the RF signal into a binary signal, and outputting the binary signal;
a rotation control section for measuring and outputting the number of edges within a predetermined time for the binary signal obtained from the RF signal;
a detecting section for detecting a missing portion of the RF signal; and
a parameter control section for, when a missing portion of the RF signal is not detected, calculating and outputting a rotation control parameter for controlling a rotation of the optical disc based on the number of edges obtained by the rotation control section, and when a missing portion of the RF signal is detected, controlling the rotation control parameter so that an influence of the missing portion of the RF signal is suppressed.
